(19) United States
(12) Patent Application Publication
(10) Pub. No.: US 2025/0376055 A1
(43) Pub. Date: Dec. 11, 2025

(54) SYSTEMS AND METHODS FOR ENABLING RELIABLE AND SECURE CHARGING OF ELECTRIC VEHICLES

(71) Applicant: NAD Grid Corp, Cupertino, CA (US)

(72) Inventors: Thomas Shaofeng Sun, Cupertino, CA (US); Bianca Lontoc, Cupertino, CA (US)

(73) Assignee: NAD Grid Corp, Cupertino, CA (US)

(21) Appl. No.: 18/564,682

(22) PCT Filed: Jun. 3, 2022
(86) PCT No.: PCT/US2022/032272

§ 371 Date: Nov. 28, 2023

Related U.S. Application Data
(60) Provisional application No. 63/197,569, filed on Jun. 7, 2021.

(51) Int. Cl. B60L 53/18; B60L 53/30

(52) U.S. Cl. CPC B60L 53/18; B60L 53/305

(57) ABSTRACT

A system and method for electric vehicle charging, the system comprising: a cable having a first interface to a charging port of an electric vehicle and a second interface to an electric vehicle service equipment (EVSE) unit; a locking subsystem at the second interface and assignable to a user of the electric vehicle, the locking subsystem transitionable between: a locked mode and an unlocked mode; and an authentication subsystem positioned proximal the second interface and comprising: an identification chip linked to an account of the user, architecture for communication of an identifying signal of the identification chip with a reader coupled to the EVSE unit, and optionally, a shield.

### CROSS-REFERENCE TO RELATED APPLICATIONS

This application claims the benefit of U.S. Provisional Application No. 63/197,569, filed on Jun. 7, 2021, and is a submission under 35 U.S.C. 371 based on PCT/US22/32272 filed on Jun. 3, 2022, which are each incorporated in its entirety herein by this reference.

### TECHNICAL FIELD

The disclosure generally relates to charging of electric vehicles.

### BACKGROUND

Traditional electric vehicle service equipment (EVSE) units typically include wired connections configured to interface with electric vehicles during charging sessions. However, flaws inherent to the designs of the wired connections are known to eventually produce problems associated with, for example: proper operation within a limited range of environmental conditions; generation of hazards for pedestrians and other entities crossing the wired connections; inability to enable curb-side charging; lack of security associated with authenticated or user-specific charging sessions; and/or other issues associated with management of the wired connections.

Thus, there is a need in the field of electric vehicle charging for improved systems and methods for providing reliable, robust, and secure charging of electric vehicles.

### INCORPORATION BY REFERENCE

All publications, patents, and patent applications mentioned in this specification are herein incorporated by reference in their entireties for all purposes and to the same extent as if each individual publication, patent, or patent application was specifically and individually indicated to be incorporated by reference.

Furthermore, where a range of values is provided, it is understood that each intervening value, between the upper and lower limit of that range and any other stated or intervening value in that stated range is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either both of those included limits are also included in the invention.

### BRIEF DESCRIPTION OF THE FIGURES

FIG. 1 depicts a schematic of an embodiment of a system for enabling secure and reliable charging.

FIG. 2 depicts a schematic of an example cross section of a cable of a system for enabling secure and reliable charging.

FIG. 3 depicts a schematic of an example cable profile of a system for enabling secure and reliable charging.

FIG. 4 depicts schematics of example plug types of a system for enabling secure and reliable charging.

FIG. 5A depicts an example locking subsystem of a system for enabling secure and reliable charging.

FIG. 5B depicts an example locking subsystem flow for enabling secure and reliable charging.

FIGS. 6A-6B depict variations of an authentication subsystem of an embodiment of a system for enabling secure and reliable charging.

FIGS. 7A-7C depict variations of a shield of an authentication subsystem of an embodiment of a system for enabling secure and reliable charging.

FIG. 8 depicts an embodiment of a computing and control subsystem operable to execute various functions associated with the cable.

### DESCRIPTION OF THE EMBODIMENTS

The following description of the embodiments (e.g., including variations of embodiments, examples of embodiments, specific examples of embodiments, other suitable variants, etc.) is not intended to be limited to these embodiments, but rather to enable any person skilled in the art to make and use the invention(s).

### 1. Benefits and Applications

The invention(s) described can confer several benefits over conventional systems and methods.

For instance, the invention(s) can provide the benefit of enabling proper operation and reliable charging sessions within a less limited range of environmental conditions. In more detail, in cold-weather or snowy environments, active charging sessions result in heat transfer from wired connections to snow and ice in proximity to the wired connections. Traditionally, termination of charging sessions causes re-freezing of water about the wired connections, which results in damage of the connections, inability to move the wired connections, and/or other operational difficulties for the end-user or EVSE maintenance entity. The invention(s) mitigate these issues.

The invention(s) can additionally or alternatively mitigate issues associated with generation of tripping hazards for pedestrians and/or other entities traversing paths crossing a wired connection between an EVSE and an electric vehicle.

The invention(s) can additionally or alternatively enable mechanisms for provision of curb-side charging sessions between EVSEs and electric vehicles, in accordance with regulations.

The invention(s) can additionally or alternatively provide structures and mechanisms for secure charging associated with authenticated charging sessions uniquely associated with an electric vehicle, user, fleet operator, and/or other entity associated with one or more electric vehicles.

The invention(s) can additionally or alternatively include electronic elements with associated software and/or firmware architecture for providing secure charging sessions that are robust against hacking and/or forms of cyber attacks.

The invention(s) can additionally or alternatively provide other suitable benefits.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. The present disclosure is capable of other and different embodiments, and its several details are capable of modifications in various obvious respects, all without departing from the disclosure. Accordingly, the drawings and description are to be regarded as illustrative in nature, and not as restrictive.

Additional aspects and advantages of the present disclosure will become readily apparent to those skilled in this art from the following detailed description, wherein only illustrative embodiments of the present disclosure are shown and described. The present disclosure is capable of other and different embodiments, and its several details are capable of modifications in various obvious respects, all without departing from the disclosure. Accordingly, the drawings and description are to be regarded as illustrative in nature, and not as restrictive.

### 2. System

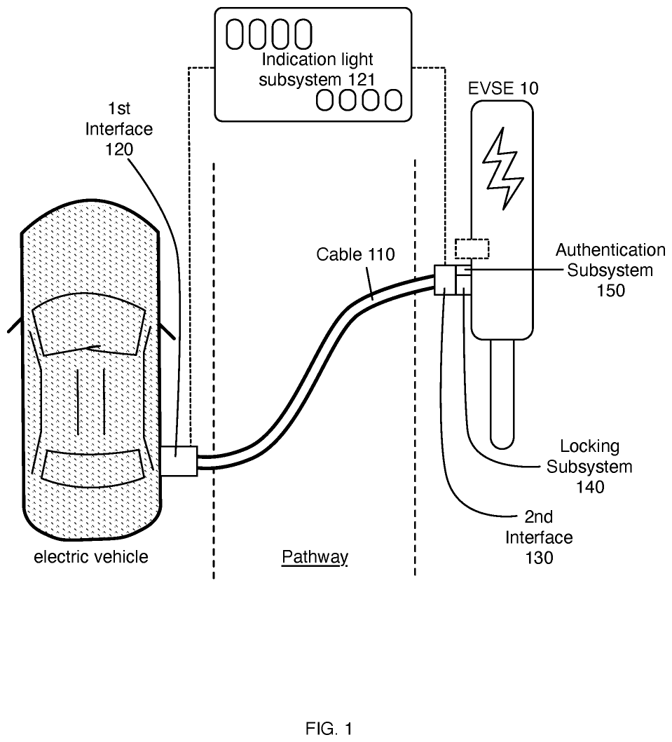

As shown in FIG. 1, an embodiment of a system 100 for electric vehicle charging can include: a cable 110 having a first interface 120 to an electric vehicle (e.g., a charging port of an electric vehicle) and a second interface 130 to an electric vehicle service equipment (EVSE) unit 10; a locking subsystem 140 at the second interface 130; and an authentication subsystem 150 comprising architecture for communication with an authenticating portion of the EVSE. The system 100 can additionally or alternatively include a portion, in proximity to the authentication subsystem 150, configured to support or provide a shield 160 (shown and described below) for preventing unauthorized access to the authentication subsystem 150 in association with a charging session.

The system 100 functions to provide a wider range of environmental conditions in which electric vehicle charging sessions can be safely and reliably conducted, without generation of hazards for pedestrians and other entities, without creating situations that provide stresses (e.g., mechanical stresses, thermal stresses, etc.) on the cable 110, with the ability to enable curb-side charging, and with the ability to provide secure, authentication charging sessions.

The system 100 can operate in coordination with embodiments, variations, and examples of methods described in one or more of: U.S. patent application Ser. No. 16/983,175 filed on Aug. 3, 2020, and U.S. patent application Ser. No. 17/163,638 filed on Feb. 1, 2021, each of which is incorporated herein in its entirety by this reference.

### 2.1 System—Cable

The cable 110 functions to provide an electrical path for current transmission between an EVSE 10 and an electric vehicle 20 in association with a charging session. Preferably, the cable 110 is structured and designed to adhere to standards for electric vehicle charging cable products, and in variations, standards can include one or more of: an IEC62893 standard, an EN50620 standard, a UL62 standard, a GB/T 33594 standard, a CQC1103-1105 standard, a DEKRA K175 standard, a TUV 2pfg 1908 standard, or another suitable standard.

The cable 110 preferably has a length that allows the cable 110 to reach from an EVSE or other power output device to the charging port of the electric vehicle, without creating an obstruction (e.g., a tripping hazard, an obstruction across a path, an obstruction due to the cable not resting on the ground, etc.). The length of the cable 110 can also have a suitable length so as to not be difficult for the user to manage (e.g., in terms of overall weight of the cable 110, in terms of unwieldiness due to length, etc.) during operation. The length of the cable 110 is also preferably designed to provide suitable electrical resistance properties (e.g., in coordination with conductive materials of the cable, cable diameter, etc.). The cable 110 can further be configured to self-wind or auto-recoil (e.g., due to incorporation of elastomeric materials, due to incorporation of materials that are able to elastically deform and return to a coiled state, etc.). In examples, the cable 110 can have a length from 1.5 meters to 10 meters, or another suitable length.

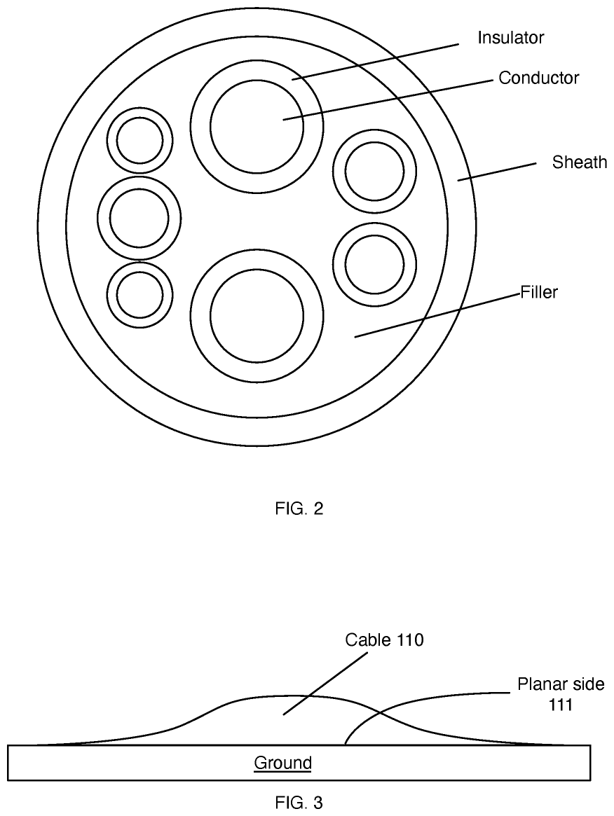

In variations, the cable 110 can be assembled with one or more conductors (e.g., as shown in FIG. 2) ensheathed by one or more insulating layers with filler materials (e.g., to retain cable sub-elements in position) and/or one or more sheaths surrounding the cable assembly for protection of cable sub-elements.

In relation to electrical properties, conductive materials of the cable 110 can be configured for operation with currents up to 20 amps, up to 30 amps, up to 40 amps, up to 50 amps, and/or up to another suitable current threshold. Furthermore, conductive materials of the cable 110 can be configured for operation in single or multiple phases (e.g., DC, AC), at up to 5 kilowatts, up to 6 kilowatts, up to 7 kilowatts, up to 8 kilowatts, up to 9kilowatts, up to 10 kilowatts, up to 15 kilowatts, up to 20 kilowatts, or up to another suitable power threshold. Additionally or alternatively, conductive materials of the cable 110 can be configured for operation at an operating voltage of from 100V to 260V (or another suitable range). However, the conductive materials of the cable can alternatively have other suitable electrical properties.

In relation to thermal properties, the materials of the cable 110 can be configured with suitable properties in relation to operating temperatures (e.g., from −40 C to 200 C), in relation to flame retardancy (e.g., at class Vo, at another suitable class of inflammability), in relation to insulation characteristics (e.g., with respect to transfer of heat during charging operations to the environment), in relation to coefficients of thermal expansion, and/or in relation to other suitable thermal properties. In relation to thermal properties, materials of the cable 110 can be insulative and/or provide passive cooling. Additionally or alternatively, the cable 110 can including cooling structures (e.g., channels that contain coolant), in order to provide a mechanism for active cooling of the cable 110 (e.g., by conduction, by convection, by radiation).

In relation to mechanical properties, the materials of the cable 110 can be configured with suitable properties under tension (e.g., along a longitudinal axis of the cable 110), under shear, under compression (e.g., along a longitudinal axis of the cable 110, transverse to a longitudinal axis of the cable 110, etc.), under torsion, in relation to fatigue resistance, in relation to crack propagation resistance, in relation to bending radius (e.g., a bending radius between 2 and 10 times the diameter of the cable 110), in relation to mechanical life with respect to insertion at the EVSE and/or at the electric vehicle (e.g., rated for operation and insertion/removal up to 10,000 times, rated for operation and insertion/removal up to 20,000 times, rated for operation and insertion/removal up to 30,000 times, rated for operation and insertion/removal up to 40,000 times rated for operation and insertion/removal for another suitable number of times), in relation to stress modulus, in relation to elastic and/or inelastic deformation characteristics, and/or in relation to other suitable mechanical properties.

In relation to surface properties (interior surface properties, exterior surface properties), the cable 110 can be configured to have suitable acid resistance, alkali resistance, water resistance (e.g., hydrophobicity, waterproofing, hermetic sealing, etc.) according to IP ratings (e.g., IP67 rating, etc.) or other suitable ratings, oil resistance, abrasion resistance, UV resistance, and/or other suitable surface characteristics for protection of the cable 110 against environmental conditions (e.g., associated with outdoor charging, associated with indoor charging). In variations, materials used can be configured to environmental protection standards (e.g., RoHS2.0 standards, other suitable standards).

In variations, the cable 110 can include aesthetic features (e.g., markings) that function to facilitate with alignment, orientation, and/or branding of the cable 110. Additionally or alternatively, the cable 110 can include morphological features that prevent generation of obstructions and/or hazards during use. For instance, the cable 110 can be configured with a non-circular cross section (e.g., at an intermediate portion along the length of the cable 110, along the entirety of the cable 110, etc.) that promotes preferential positioning of the cable 110 with a flattened (e.g., planar side 111) or tapered profile against the ground between the EVSE and the electric vehicle, an example of which is shown in FIG. 3. Furthermore, the planar side 111 of the cable 110 can be weighted (e.g., in comparison to other portions of the cable), such that the planar side 111 preferentially positions itself against the ground when the cable is in use.

In relation to morphological configurations in which the cable 110 is be configured with a non-circular cross section, the cable 110 can additionally or alternatively include asymmetric distribution of thermal properties (e.g., at different regions of the cable 110). For instance, for operation in snowy/icy environments, a planar side 111 of the cable 110 can be configured to allow heat transfer from the cable 110 (e.g., during charging), such that heat generated from the cable melts snow/ice under the cable 110 during use, to allow the cable 110 to remain positioned properly on the ground. However, the cable 110 can additionally or alternatively have other suitable morphological features and/or cross-sectional profiles and/or distribution of features.

### 2.2 System—Electric Vehicle Interface

As shown in FIG. 1, the cable 110 has a first interface 120 to an electric vehicle (e.g., a charging port of an electric vehicle), where the first interface 120 functions to reversibly mate with a charging port of the electric vehicle to enable charging of the electric vehicle during charging sessions. The first interface 120 can have electrical properties, thermal properties, mechanical properties, surface properties and/or other properties (e.g., variations of which are described above). Preferably, the cable 110 has a first end which terminates at the first interface 120, and the first interface 120 is coupled to and seals the first end of the cable 110; however, the first interface 120 can be coupled to and/or positioned along the cable 110 in another suitable manner. Furthermore, in variations, the first interface can include a grip (e.g., pistol grip) and/or other handle component with suitable impact resistance properties (e.g., IP44 rated impact-resistance for ‘run over’ protection, etc.).

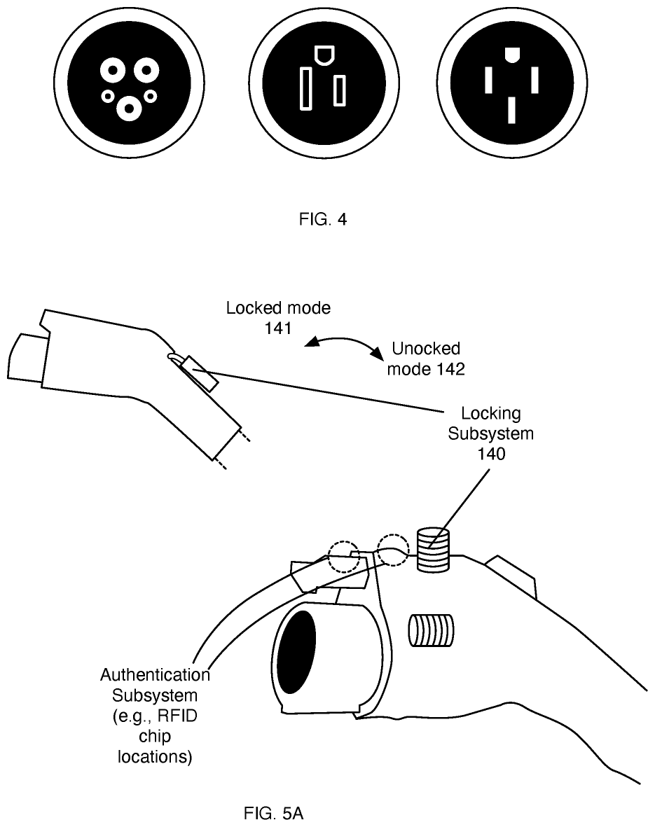

In variations, the first interface 120 includes a plug configured to reversibly mate with the charging port of the electric vehicle. In variations, the plug can have one of the following forms: type 2 (IEC 62196-2 plug); type 1 (J1772 plug); other form (e.g., with pins for one or more of pre-insertion signaling, post-insertion signaling, protective earthing, lines for AC operation, lines for DC operation, lines for low-current operation, lines for mid-current operation, etc.), and/or any other suitable form. Example plug types are shown in FIG. 4.

In variations, the plug of the first interface 120 can be modularly attached to the cable 110/first interface 120, such that the cable 110 can be modularly adapted for interfacing with different types of electric vehicle ports. However, the plug can alternatively be permanently coupled to the first interface 120/cable 110 and not a removable component.

In variations, the first interface 120 can additionally or alternatively include indication elements that transition between various modes for indication of statuses of the cable 110 and/or devices connected to the cable 110. For instance, the indication elements can include indicator lights that indicate statuses of the cable 110 (e.g., an improper insertion status, a proper insertion status, a damaged cable status, statuses associated with power output of the EVSE, statuses associated with charge state of the electric vehicle, etc.). Additionally or alternatively, indication elements can include audio output devices, haptic feedback devices, visual output devices, and/or other suitable output devices.

Indication elements of the first interface 120, second interface 130 (described in more detail below), and/or other cable 110 portion can additionally or include electronic architecture for communication of statuses of the cable 110, EVSE, and/or electric vehicle to another device (e.g., mobile computing device, wearable computing device, other smart device, etc.). Communicated statuses can then be used by the system 100 to return notifications (e.g., to the electric vehicle operator, to a fleet manager, to another entity) and/or execute other actions pertaining to statuses of the cable 110, EVSE, and/or electric vehicle, where example executed actions can include generation of instructions to control states of the EVSE (e.g., power output modes of the EVSE, idle modes of the EVSE, on-off modes of the EVSE, etc.), generation of instructions pertaining to the cable (e.g., replacement of a damaged cable, recommended non-use of a cable exhibiting abnormal behavior, etc.), and/or generation of instructions to control states of the electric vehicle. As such, the first interface 120 can include an indication light subsystem 121 configured to receive electrical signals encoding a set of statuses of the EVSE unit, the cable, and the electric vehicle, and to generate light signals indicative of one or more of the set of statuses to the user.

The first interface 120 can, however, include other suitable elements.

### 2.3 System—EVSE Interface

As shown in FIG. 1, the system 100 also includes a second interface 130 to an electric vehicle service equipment (EVSE) unit 10, which functions to reversibly mate with a port of the EVSE to enable power output by the EVSE to charge the electric vehicle according to various charging modes/sessions. The second interface 120 can have electrical properties, thermal properties, mechanical properties, surface properties and/or other properties (e.g., variations of which are described above). Preferably, the cable 110 has a second end which terminates at the second interface 130, and the second interface 130 is coupled to and seals the second end of the cable 110; however, the second interface 130 can be coupled to and/or positioned along the cable 110 in another suitable manner. Furthermore, in variations, the second interface 130 can include a grip (e.g., pistol grip) and/or other handle component with suitable impact resistance properties (e.g., IP44 rated impact-resistance for ‘run over’ protection, etc.).

In variations, the second interface 130 includes a plug configured to reversibly mate with the port of the EVSE. In variations, the plug can have one of the following forms: type 2 (IEC 62196-2 plug); type 1 (J1772 plug); other form (e.g., with pins for one or more of pre-insertion signaling, post-insertion signaling, protective earthing, lines for AC operation, lines for DC operation (e.g., DC quick charging), lines for low-current operation, lines for mid-current operation, etc.), and/or any other suitable form.

In variations, the plug of the second interface 130 can be modularly attached to the cable 110/second interface 130, such that the cable 110 can be modularly adapted for interfacing with different types of electric vehicle ports. However, the plug can alternatively be permanently coupled to the second interface 130/cable 110 and not a removable component.

In variations, the second interface 130 can additionally or alternatively include indication elements that transition between various modes for indication of statuses of the cable 110 and/or devices connected to the cable 110, in a manner similar to that described in relation to the first interface 120 above. Indication elements of the first interface 120, second interface 130, and/or other cable 110 portion can additionally or include electronic architecture (e.g., transmission architecture) for communication of statuses of the cable 110, EVSE, and/or electric vehicle to another device (e.g., mobile computing device, wearable computing device, other smart device, etc.), as described above. As such, the second interface 130 can include an indication light subsystem 121 configured to receive electrical signals encoding a set of statuses of the EVSE unit, the cable, and the electric vehicle, and to generate light signals indicative of one or more of the set of statuses to the user.

The second interface 130 can, however, include other suitable elements, embodiments, variations, and examples of which are described in further detail below.

### 2.3.1 Second Interface—Locking Elements

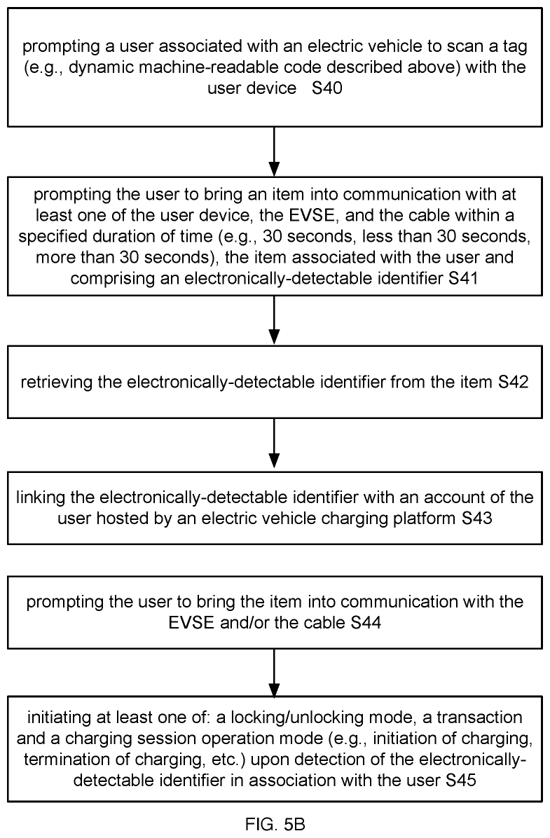

As shown in FIGS. 1 and 5, variations of the cable 110 can include a locking subsystem 140 at the second interface 130, which functions to allow the electric vehicle operator or another entity to controllably lock the second interface 130 with the port of the EVSE. As such, the locking subsystem 140 is configured to prevent undesired or unapproved removal of the second interface 130 from the EVSE (e.g., by someone unaffiliated with the electric vehicle or electric vehicle operator/manager).

The locking subsystem 140 can include mechanical and/or electrical locking mechanism components. In one variation, as shown in FIG. 5A, the locking subsystem 140 includes a combination lock mechanism that transitions a latch (e.g., a latch positioned near the plug of the second interface 130) between a locked mode 141 and an unlocked mode 142, where input of a predetermined code (e.g., alphanumeric code) transitions the latch from the locked mode to the unlocked mode and allows the second interface 130 to be released from coupling with the EVSE. Additionally or alternatively, the locking subsystem 140 can be activated/deactivated by a biometric input (e.g., fingerprint, thumbprint, voice signature, eye signature, facial feature signature, etc.).

As such, the locked mode 141 can be activated upon coupling the second interface to the EVSE unit and configured to prevent uncoupling of the second interface from the EVSE unit, and the unlocked mode 142 can be activated in response to an input (e.g., code input) provided by the user and enable uncoupling of the second interface from the EVSE unit.

In variations of the locked mode, if a non-user (e.g., cable thief) attempts to connect the second interface 130 to the EVSE unit, and the cable 110 has been reported as missing/stolen by the user, the system can be configured to transmit a notification to the user through a device of the user, in order to facilitate retrieval of the cable 110 by the user and/or prevent unauthorized use of the cable. As such, in relation to the locking subsystem 140 and the authentication subsystem 150 (described in further detail below), the system can include architecture that recognizes the cable 110 as being associated with an account of a user (e.g., mobile device application account, web account, platform account, etc.) through an identification chip, read the identification chip, and prevent unlocking of the cable (or perform another suitable anti-theft action, such as temporarily deactivating the cable 110) if the cable 110 is subject to unauthorized use. Still alternatively, the locking subsystem 140 can include location tracking components capable of transmitting a location of the cable 110 (e.g., with beacons, with global positioning system elements, etc.).

In another mechanical variation, the locking subsystem 140 can include a key lock mechanism that transitions a latch (e.g., a latch positioned near the plug of the second interface 130) between a locked mode and an unlocked mode, where insertion and/or twisting of the key into the key lock mechanism transitions the latch from the locked mode to the unlocked mode and allows the second interface 130 to be released from coupling with the EVSE.

Additionally or alternatively, the locking subsystem 140 can include an electronic locking interface. In one variation, the electronic locking interface can include a pad (e.g., touch pad, key pad, etc.) responsive to touch input by a user, where input of a code (e.g., alphanumeric code, swipe pattern, etc.) transitions the plug and/or second interface 130 from a locked mode to an unlocked mode and allows the second interface 130 to be released from coupling with the EVSE. In another related variation, the electronic locking interface can include an optical sensor and associated architecture for processing a biometric signature (e.g., fingerprint, thumbprint, facial feature, eye feature, etc.) of the user or other operator of the cable 110, where authentication based upon the biometric signature transitions the latch from the locked mode to the unlocked mode and allows the second interface 130 to be released from coupling with the EVSE. In another related variation, the electronic locking interface can include a microphone and associated architecture for processing a biometric signature (e.g., voice, etc.) of the user or other operator of the cable 110, where authentication based upon the biometric signature transitions the latch from the locked mode to the unlocked mode and allows the second interface 130 to be released from coupling with the EVSE.

### 2.3.1.1 Locking/Unlocking With User-Associated Objects and Devices

Additionally or alternatively, in another variation, the locking interface can be unlocked based upon communication (e.g., wireless communication) with an authenticated device, such as a fob, mobile computing device, wearable computing device, card, chip, and/or other computing device of an authenticated entity associated with the cable 110. In examples, objects/devices that can be uniquely identified with the user's account can include: employee badges, housing key fobs, hotel keys, other charging network RFID cards, credit cards (e.g., encrypted credit card information), wearable electronic devices (e.g., Apple™ wearable devices, Android™ wearable devices, etc.), and other objects. Thus, with a valid/verified account (e.g., within an overarching platform for charging), where the overarching system provides user interfaces through a mobile device application or a web application, the user can add any and/or multiple objects and devices to his/her account, for use to facilitate charging using the cable.

In some embodiments, the overarching system can include architecture for linking user-associated objects and/or other devices with a user identification or account of the user, in order to allow the user to interact with an EVSE (e.g., authenticate a charging sessions, initiate a charging session, terminate a charging session, etc.) and/or cable 110 using the user-associated objects and/or other devices.

In one example, the overarching system described allows any suitable object or device to serve as a unique identifier for association with a user account stored at the overarching system, in order to facilitate charging sessions. As such, users can interact with EVSEs, cables 110, and/or the overarching system without carrying additional items beyond what they would normally have to carry.

In examples, objects/devices that can be uniquely identified with the user's account can include: employee badges, housing key fobs, hotel keys, other charging network RFID cards, credit cards (e.g., encrypted credit card information), wearable electronic devices (e.g., Apple™ wearable devices, Android™ wearable devices, etc.), and other objects. Thus, with a valid/verified account within the overarching system, where the overarching system provides user interfaces through a mobile device application or a web application, the user can add any and/or multiple objects and devices to his/her account, for use to facilitate charging of an associated electric vehicle.

In an example implementation, once the object(s) and/or device(s) is/are associated with the user's account via an appropriate interface (e.g., mobile application interface, web interface), the user can present the object(s) and/or device(s) at the EVSE and/or sensor of the cable 110 (e.g., by scanning, by swiping). The overarching system then uses the unique ID of the object(s)/device(s) to look up the user's platform account and can subsequently perform an action (e.g., initiate a charging session) with the payment method set up for the user. As such, any item (e.g., RFID, other device, other active object, or credit card) can be simply used as a unique identifier for the user. In embodiments where the item is capable of facilitating a transaction (e.g., such as in a credit card), the item can function as a user identifier without being involved in a financial transaction; however, the item can additionally be used in a financial transaction associated with electric vehicle charging, in coordination with user identification/authentication.

In embodiments where the user has multiple object(s) and/or device(s) associated with his/her account, the overarching system can prompt the user (e.g., through the EVSE, through the mobile application, through the web application, etc.), to present a subset or all of the multiple object(s) and/or device(s) for detection, as a form of multi-factor authentication. As such, embodiments where the user has multiple object(s) and/or device(s) associated with his/her account can provide a mechanism for improved security of transactions through multi-factor authentication.

In one variation of implementation, as shown in FIG. 5B, the method can include: prompting a user associated with an electric vehicle to scan a tag (e.g., dynamic machine-readable code described above) of an EVSE (e.g., in a prior interaction) with the user device S40, where scanning can occur outside of a platform-specific application environment (e.g., with a general-use camera application); prompting the user to bring an item into communication with at least one of the user device, the cable 110, and the EVSE within a specified duration of time (e.g., 30 seconds, less than 30 seconds, more than 30 seconds), the item associated with the user and comprising an electronically-detectable identifier S41; detecting the electronically-detectable identifier from the item S42; and linking the electronically-detectable identifier with an account of the user hosted by an electric vehicle charging platform S43. Then, in association with an intended charging session, the method can include: prompting the user to bring the item into communication with the EVSE and/or the cable S44; and initiating at least one of: a locking/unlocking mode, a transaction and a charging session operation mode (e.g., initiation of charging, termination of charging, etc.) upon detection of the electronically-detectable identifier in association with the user S45.

This variation of the method is configured to prevent challenges arising from a user's lack of knowledge of encoded, hidden, or otherwise unknown identifiers of the item/object/device intended to be added to the user's account. This variation of the method can also prevent challenges arising from the presence of multiple identifiers associated with the item/object/device intended to be added to the user's account, which can create in relation to different readers at different EVSEs configured to read different types of identifiers.

Additional embodiments, variations, and examples of linking of objects with a user account are described in U.S. application Ser. No. 17/163,638 filed on 1 Feb. 2021, which is herein incorporated in its entirety by this reference. As such, authentication based upon interfacing the object with the electronic locking interface transitions the locking mechanism from the locked mode to the unlocked mode and allows the second interface 130 to be released from coupling with the EVSE.

Variations of the cable 110 can additionally or alternatively include an embodiment, variation, or example of the locking subsystem 140 at the first interface 120 described above.

### 2.3.2 Second Interface—Authentication Elements

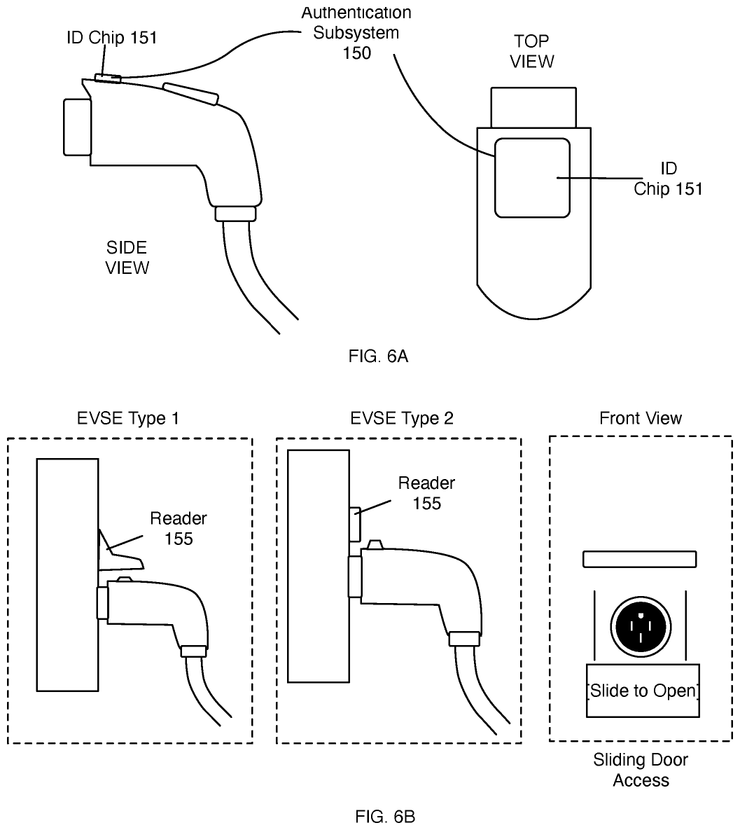

As shown in FIGS. 1 and 6A-6B, the cable 110 also includes an authentication subsystem 150 comprising architecture for communication with an authenticating portion of the EVSE. The authentication subsystem includes electronic components and architecture that uniquely identifies the cable 110 and is associated with an account of the user (e.g., within an overarching platform for charging), where the overarching system provides user interfaces through a mobile device application and/or a web application.

The authentication subsystem can be positioned proximal (e.g., near) the second interface 130, such that connecting the second interface 130 into the EVSE unit allows a reader of the EVSE unit to read an identification chip or other element of the cable 110. However, the authentication subsystem can be otherwise positioned.

In one example, the authentication subsystem 150 of the cable 110 includes an identification chip 151, such as a radio-frequency identification (RFID) chip implementing electromagnetic fields to enable automatic identification of the RFID chip and associated cable 110 linked to the account of the user. The RFID chip can be a passive tag powered by energy from a corresponding reader 155 of the EVSE, where the reader of the EVSE can enable charging upon authentication of the cable by way of the RFID chip. Embodiments of the system can thus include architecture for communication of an identifying signal of the identification chip with a reader 155 coupled to the EVSE unit for enabling charging sessions associated with at least one of the electric vehicle and the account of the user.

Alternatively, the RFID chip can be an active tag powered by a power subsystem (e.g., battery) of the cable 110 to provide greater range of detection and/or through shielding (described in more detail below). In variations of the example, the authentication subsystem 150 can additionally or alternatively include one or more of: ultra wide-band (UWB) real time locating system (RTLS) elements, WiFi RTLS elements, infrared RTLS elements, optically-detected tags (e.g., QR codes, barcodes, codes observable by LIDAR systems, etc.), other tags detectable at other electromagnetic frequencies, other tags detectable at other audible frequencies, and/or other tags or chips for authentication. The tags/chips can be permanently integrated with the cable 110 at the second interface 130 and/or alternatively replaceable (e.g., in the event that the tag/chip is damaged or otherwise rendered non-functional).

In variations involving an integrated or replaceable authentication tag or chip, users can manage their associated cables 110 and authentication tags by way of an account within an overarching platform. Thus, with a valid/verified account (e.g., within an overarching platform for charging), where the overarching system provides user interfaces through a mobile device application or a web application, the user can add any and/or multiple cables and associated devices to his/her account. Embodiments, variations, and examples of linking of objects with a user account are described in U.S. application Ser. No. 17/163,638 filed on 1 Feb. 2021, which is incorporated by reference above.

In alternative variations, the cable 110 can omit an authentication tag, and authentication can be provided by way of another authenticating object, as described above and in U.S. application Ser. No. 17/163,638 filed on 1 Feb. 2021, in order to enable secure charging sessions using an embodiment of the cable 110.

In variations where the authentication subsystem 150 includes an integrated or replaceable authentication tag or chip, the user experience is designed such that, as the user plugs in the cable, authentication happens simultaneously by way of the reader of the EVSE. As such, the user may not be aware of or require additional action for authenticated sessions, and from the user's perspective, charging happens seamlessly upon plugging the cable 110 into the EVSE.

### 2.3.3 Second Interface—Authentication Security

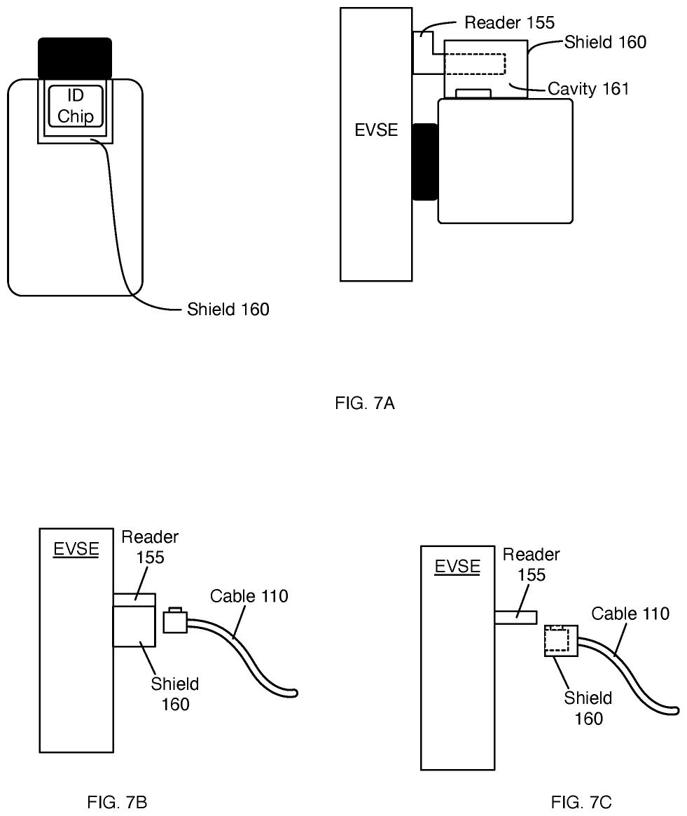

As shown in FIGS. 7A-7C, the system 100 can additionally or alternatively include a portion, in proximity to the authentication subsystem 150, configured to support or provide a shield 160 for preventing unauthorized access to the authentication subsystem 150 in association with a charging session. As such, the shield is configured to prevent reading of outside signals (e.g., signals from another cable 110, signals from an intruding device, etc.) unassociated with the identification chip, when the second interface is coupled to the EVSE unit.

The shield 160 can be coupled to the EVSE, as shown in FIG. 7B, or the shield 160 can alternatively be coupled to the cable 110 (e.g., about the second interface 130) as shown in FIG. 7C In variations, the shield 160 includes one or more walls (e.g., a wall having curved sides, a wall having a straight sides, etc.) surrounding the second interface 130 in a manner that only allows for interactions between the authentication reader of the EVSE with the authentication subsystem 150 of the cable 110, and blocks other interactions (e.g., prevents another reader from reading the identification chip, prevents another device from interacting with the reader). As such, the shield 160 can define a cavity 161 configured to receive the reader of the EVSE unit for communication with the identification chip of the cable.

In one variation, as shown in FIGS. 7A and 7B, the reader of the EVSE can be positioned superior to the port for the cable 110 (e.g., such that the reader is configured to read the chip/tag of the cable 110 from above), and the wall(s) of the shield 160 are positioned about the second interface 130 to provide a shield about the sides and bottom of the second interface 130. However, in other variations, the wall(s) of the shield can be otherwise positioned about the second interface 130 in another suitable manner (e.g., depending upon orientation of the reader relative to the chip/tag of the second interface 130).

In variations, the wall(s) of the shield 160 can be composed of a conductive material. In examples, the conductive material can include one or more of: copper, aluminum, steel, or another suitable conductive material. Alternatively, the wall(s) of the shield 160 can be composed of another suitable material. As such, the material(s) of the wall(s) can provide passive shielding of the second interface 130 and/or other cable 110 portion associated with the authentication subsystem 150, in order to prevent intrusion. Alternatively, the wall(s) of the shield 160 and/or another suitable portion of the second interface 130 can include active shielding elements (e.g., elements configured to emit frequencies or otherwise obstruct attempted connections with non-authenticated objects).

### 2.4 System—Other Elements

In variations, the cable 110 and/or other related portion of the system 100 can include other sensors configured to detect statuses of the cable 110 and/or devices (e.g., electric vehicles, EVSEs, etc.) coupled to the cable 110. In variations, the other sensors can include one or more of: thermal sensors (e.g., to detect temperatures of the cable 110 in association with proper operation, heating, cooling, etc.), sensors configured to detect electrical characteristics (e.g., voltage, current, resistance) of the cable 110 and/or elements coupled to the cable 110, force sensors to detect mechanical forces (e.g., shear, compression, tension, torsion, bending, etc.) applied to the cable 110 and/or elements coupled to the cable 110, sensors operable to detect other failure (e.g., compromise of sheathing material, compromise of plugs, etc.) of the cable 110, humidity sensors configured to detect potential damage to the cable 110 by intrusion of moisture, and/or other suitable sensors.

Such sensors can be in communication with a processor or other computing and control subsystem, such that sensor outputs can be used to transition the cable 110 between different operating modes (e.g., fail-safe modes) and/or inform relevant entities (e.g., electric vehicle owners, EVSE site managers, etc.) of operational states of the cable 110, the EVSE(s) involved, and/or the electric vehicles involved. Computing and control subsystem elements are described in Section 3 below.

The system 100 can, however, include other suitable elements configured to promote proper operation of the cable 110 and/or facilitate performance of secure charging sessions in another suitable manner.

### 3. Computer Systems

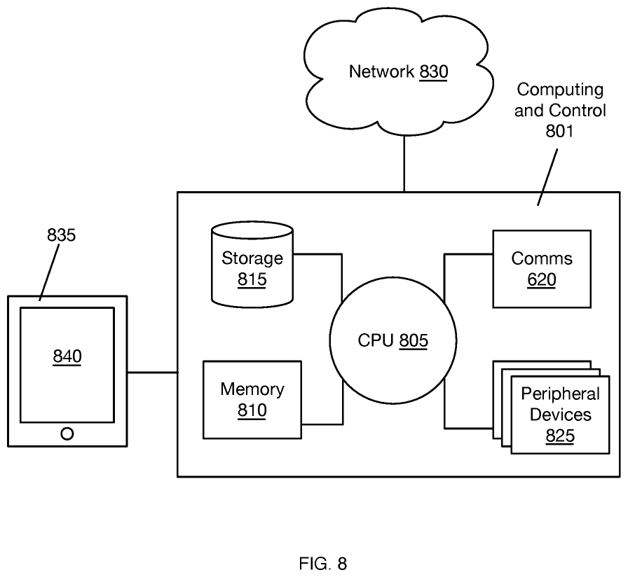

The present disclosure provides computing and control subsystems that are programmed to implement methods associated with use of the cable 110. FIG. 8 shows a computing and control subsystem 801 that is programmed or otherwise configured to, for example, facilitate charging of an electric vehicle, with desired security, authentication, and locking functionalities associated with various types of charging sessions and/or different users.

The computing and control subsystem 801 includes architecture for regulating various aspects of authentication, charging regulation, locking, and other functionalities of the present disclosure. The computing and control subsystem 801 can be an electronic device of a user or a computer system that is remotely located with respect to the electronic device. The electronic device can be a mobile electronic device.

The computing and control subsystem 801 includes a central processing unit (CPU, also “processor” and “computer processor” herein) 805, which can be a single core or multi core processor, or a plurality of processors for parallel processing. The computing and control subsystem 801 also includes memory or memory location 810 (e.g., random-access memory, read-only memory, flash memory), electronic storage unit 815 (e.g., hard disk), communication interface 820 (e.g., network adapter) for communicating with one or more other systems, and peripheral devices 825, such as cache, other memory, data storage and/or electronic display adapters. The memory 810, storage unit 815, interface 820 and peripheral devices 825 are in communication with the CPU 805 through a communication bus (solid lines), such as a motherboard. The storage unit 815 can be a data storage unit (or data repository) for storing data. The computer system 601 can be operatively coupled to a computer network (“network”) 830 with the aid of the communication interface 820. The network 830 can be the Internet, an internet and/or extranet, or an intranet and/or extranet that is in communication with the Internet.

In some embodiments, the network 830 is a telecommunication and/or data network. The network 830 can include one or more computer servers, which can enable distributed computing, such as cloud computing. For example, one or more computer servers may enable cloud computing over the network 830 (“the cloud”) to perform various aspects of facilitating charging of an electric vehicle, with desired security, authentication, and locking functionalities associated with various types of charging sessions and/or different users. Such cloud computing may be provided by cloud computing platforms such as, for example, Amazon Web Services (AWS), Microsoft Azure, Google Cloud Platform, and IBM cloud. In some embodiments, the network 830, with the aid of the computer system 601, can implement a peer-to-peer network, which may enable devices coupled to the computer system 101 to behave as a client or a server.

The CPU 805 can include one or more computer processors and/or one or more graphics processing units (GPUs). The CPU 805 can execute a sequence of machine-readable instructions, which can be embodied in a program or software. The instructions may be stored in a memory location, such as the memory 810. The instructions can be directed to the CPU 805, which can subsequently program or otherwise configure the CPU 805 to implement methods of the present disclosure. Examples of operations performed by the CPU 805 can include fetch, decode, execute, and writeback. The CPU 805 can be part of a circuit, such as an integrated circuit. One or more other components of the computing and control subsystem 801 can be included in the circuit. In some embodiments, the circuit is an application specific integrated circuit (ASIC).

The storage unit 815 can store files, such as drivers, libraries and saved programs. The storage unit 815 can store user data, e.g., user preferences and user programs. In some embodiments, the computer system 801 can include one or more additional data storage units that are external to the computer system 801, such as located on a remote server that is in communication with the computer system 801 through an intranet or the Internet.

The computing and control subsystem 801 can communicate with one or more remote computer systems through the network 830. For instance, the computer system 601 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 601 via the network 830.

Methods as described herein can be implemented by way of machine (e.g., computer processor) executable code stored on an electronic storage location of the computing and control subsystem 801, such as, for example, on the memory 810 or electronic storage unit 815. The machine executable or machine-readable code can be provided in the form of software. During use, the code can be executed by the processor 805. In some embodiments, the code can be retrieved from the storage unit 815 and stored on the memory 810 for ready access by the processor 805. In some situations, the electronic storage unit 815 can be precluded, and machine-executable instructions are stored on memory 810.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Embodiments of the systems and methods provided herein, such as the computing and control subsystem 801, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, or disk drives, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computing and control subsystem 801 can include or be in communication with an electronic display 835 that comprises a user interface (UI) 840 for providing, for example, a visual display indicative of statuses associated with charging of an electric vehicle, security information, authentication information, and locking statuses associated with various types of charging sessions and/or different users. Examples of UIs include, without limitation, a graphical user interface (GUI) and web-based user interface.

Methods and systems of the present disclosure can be implemented by way of one or more algorithms. An algorithm can be implemented by way of software upon execution by the central processing unit 805. The algorithm can, for example, facilitate charging of an electric vehicle, with desired security, authentication, and locking functionalities associated with various types of charging sessions and/or different users.

In one set of embodiments, methods implemented by way of or as supported by the computing and control subsystem 801 can include methods for communication of statuses of the cable 110, EVSE, and/or electric vehicle to another device (e.g., mobile computing device, wearable computing device, other smart device, etc.). Communicated statuses can then be used by the system 100 to return notifications (e.g., to the electric vehicle operator, to a fleet manager, to another entity) and/or execute other actions pertaining to statuses of the cable 110, EVSE, and/or electric vehicle, where example executed actions can include generation of instructions to control states of the EVSE (e.g., power output modes of the EVSE, idle modes of the EVSE, on-off modes of the EVSE, etc.), generation of instructions pertaining to the cable (e.g., replacement of a damaged cable, recommended non-use of a cable exhibiting abnormal behavior, etc.), and/or generation of instructions to control states of the electric vehicle. Control instructions returned by outputs of architecture of the computing and control subsystem 801 can be used to transition lights of the indication light subsystem 121 between different operational states to generate light signals indicative of one or more of the set of statuses to the user.

Additionally or alternatively, methods implemented by way of or as supported by the computing and control subsystem 801 can include methods for transitioning the locking subsystem 140 between a locked mode 141 and an unlocked mode 142, in response to an input (e.g., code input, biometric input, device input, etc.) provided by the user and for enabling uncoupling of the second interface from the EVSE unit.

Relatedly, In variations of the locked mode, if a non-user (e.g., cable thief) attempts to connect the second interface 130 to the EVSE unit, and the cable 110 has been reported as missing/stolen by the user, outputs of the computing and control subsystem 801 can process digital objects associated with this situation and generate instructions for transmitting a notification to the user through a device of the user, in order to facilitate retrieval of the cable 110 by the user and/or prevent unauthorized use of the cable. As such, in relation to the locking subsystem 140 and the authentication subsystem 150, architecture of the computing and control subsystem can process objects associated with cable recognition (e.g., through an identification chip or other means) in relation to association with an account of a user (e.g., mobile device application account, web account, platform account, etc.), to prevent unlocking of the cable (or perform another suitable anti-theft action, such as temporarily deactivating the cable 110) if the cable 110 is subject to unauthorized use. Additionally or alternatively, the computing and control architecture can process information from location tracking components capable of transmitting a location of the cable 110 (e.g., with beacons, with global positioning system elements, etc.) in relation to anti-theft functionality.

Additionally or alternatively, in relation to account management by a user with multiple associated cables, the computing and control subsystem 801 can receive and process inputs for management of associated cables 110 and authentication tags by a user, and generate outputs and process inputs for user interfaces (e.g., through a mobile device application or a web application), where the user can add any and/or multiple cables and associated devices to his/her account.

Additionally or alternatively, in relation to sensors associated with the cable 110, the computing and control subsystem 801 can include architecture for processing sensor outputs including outputs associated with one or more of: thermal sensors (e.g., to detect temperatures of the cable 110 in association with proper operation, heating, cooling, etc.), sensors configured to detect electrical characteristics (e.g., voltage, current, resistance) of the cable 110 and/or elements coupled to the cable 110, force sensors to detect mechanical forces (e.g., shear, compression, tension, torsion, bending, etc.) applied to the cable 110 and/or elements coupled to the cable 110, sensors operable to detect other failure (e.g., compromise of sheathing material, compromise of plugs, etc.) of the cable 110, humidity sensors configured to detect potential damage to the cable 110 by intrusion of moisture, and/or other suitable sensors. The computing and control subsystem 801 can then process such sensor outputs, and return outputs for executing actions (e.g., in relation to generation of notifications for entities of interest, in relation to transitioning the cable between different states associated with failure modes, in relation to cable replacement operations, etc.).

Additionally or alternatively, the computing and control subsystem 801 can include architecture with programming to execute other suitable methods.

### 4. Conclusion

Embodiments of the invention(s) described can include every combination and permutation of the various system components and the various method processes, including any variants (e.g., embodiments, variations, examples, specific examples, figures, etc.), where portions of embodiments of the method 100 and/or processes described herein can be performed asynchronously (e.g., sequentially), concurrently (e.g., in parallel), or in any other suitable order by and/or using one or more instances, elements, components of, and/or other aspects of the system 200 and/or other entities described herein.

Any of the variants described herein (e.g., embodiments, variations, examples, specific examples, figures, etc.) and/or any portion of the variants described herein can be additionally or alternatively combined, aggregated, excluded, used, performed serially, performed in parallel, and/or otherwise applied.

Portions of embodiments of the invention(s) can be embodied and/or implemented at least in part as a machine configured to receive a computer-readable medium storing computer-readable instructions. The instructions can be executed by computer-executable components that can be integrated with embodiments of the system(s). The computer-readable medium can be stored on any suitable computer-readable media such as RAMs, ROMs, flash memory, EEPROMs, optical devices (CD or DVD), hard drives, floppy drives, or any suitable device. The computer-executable component can be a general or application specific processor, but any suitable dedicated hardware or hardware/firmware combination device can alternatively or additionally execute the instructions.

As a person skilled in the art will recognize from the previous detailed description and from the figures and claims, modifications and changes can be made to embodiments of the inventions, and/or variants without departing from the scope defined in the claims. Variants described herein not meant to be restrictive. Certain features included in the drawings may be exaggerated in size, and other features may be omitted for clarity and should not be restrictive. The figures are not necessarily to scale. The absolute or relative dimensions or proportions may vary. Section titles herein are used for organizational convenience and are not meant to be restrictive. The description of any variant is not necessarily limited to any section of this specification.

Furthermore, it should be understood from the foregoing that, while particular implementations have been illustrated and described, various modifications may be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

What is claimed is:

1. A system for electric vehicle charging, the system comprising:
a cable having a first interface to a charging port of an electric vehicle and a second interface to an electric vehicle service equipment (EVSE) unit;
a locking subsystem at the second interface and assignable to a user of the electric vehicle, the locking subsystem transitionable between:
a locked mode activated upon coupling the second interface to the EVSE unit and preventing uncoupling of the second interface from the EVSE unit, and
an unlocked mode activated in response to an input provided by the user and enabling uncoupling of the second interface from the EVSE unit; and
an authentication subsystem positioned proximal the second interface and comprising:
an identification chip linked to an account of the user,
architecture for communication of an identifying signal of the identification chip with a reader coupled to the EVSE unit for enabling charging sessions associated with at least one of the electric vehicle and the account of the user, and
a shield coupled to the cable about the authentication subsystem, the shield configured to prevent reading of outside signals unassociated with the identification chip, when the second interface is coupled to the EVSE unit.

2. The system of claim 1, wherein the cable comprises an intermediate portion having a non-circular cross section, the non-circular cross section comprising a planar side.

3. The system of claim 2, wherein the planar side is weighted in comparison to other portions of the cable, such that the planar side preferentially positions itself against the ground when the cable is in use.

4. The system of claim 1, wherein at least one of the first interface and the second interface comprises and indication subsystem configured to receive electrical signals encoding a set of statuses of the EVSE unit, the cable, and the electric vehicle, and to generate light signals indicative of one or more of the set of statuses to the user.

5. The system of claim 4, wherein the indication subsystem further comprises transmission architecture for communicating one or more of the set of statuses to a device of the user.

6. The system of claim 1, wherein in the locked mode, connection of the second interface to the EVSE unit activates transmission of a notification to a device of the user, if the cable has been reported as missing through the account of the user.

7. The system of claim 1, wherein in the unlocked mode, the input provided by the user comprises an alphanumeric code predetermined by the user.

8. The system of claim 1, wherein in the unlocked mode, the input provided by the user comprises a biometric signature provided by the user.

9. The system of claim 1, wherein in the unlocked mode, the input provided by the user comprises an interaction between an authenticated device of the user and the locking subsystem.

10. The system of claim 1, wherein the identification chip of the authentication subsystem comprises a radio-frequency identification (RFID) chip that is powered by the reader of the EVSE.

11. The system of claim 1, wherein the shield defines a cavity configured to receive the reader of the EVSE unit for communication with the identification chip of the cable.

12. A system for electric vehicle charging, the system comprising:
a cable having a first interface to a charging port of an electric vehicle and a second interface to an electric vehicle service equipment (EVSE) unit;
a locking subsystem at the second interface and assignable to a user of the electric vehicle, the locking subsystem transitionable between:
a locked mode preventing uncoupling of the second interface from the EVSE unit, and
an unlocked mode activated in response to an input provided by the user and enabling uncoupling of the second interface from the EVSE unit; and
an authentication subsystem positioned proximal the second interface and comprising:
an identification chip linked to an account of the user, and
architecture for communication of an identifying signal of the identification chip with a reader coupled to the EVSE unit for enabling charging sessions associated with at least one of the electric vehicle and the account of the user.

13. The system of claim 12, wherein the cable comprises an intermediate portion having a non-circular cross section, the non-circular cross section comprising a planar side, and wherein the planar side is weighted in comparison to other portions of the cable, such that the planar side preferentially positions itself against the ground when the cable is in use.

14. The system of claim 12, wherein the locked mode is activated upon coupling the second interface to the EVSE unit.

15. The system of claim 14, wherein in the locked mode, connection of the second interface to the EVSE unit activates transmission of a notification to a device of the user, if the cable has been reported as missing through the account of the user.

16. The system of claim 12, wherein at least one of the first interface and the second interface comprises and indication subsystem configured to receive electrical signals encoding a set of statuses of the EVSE unit, the cable, and the electric vehicle, and to generate light signals indicative of one or more of the set of statuses to the user.

17. The system of claim 16, wherein the set of statuses comprises statuses associated with damage and improper functioning of the cable.

18. The system of claim 12, wherein in the unlocked mode, the input provided by the user comprises a biometric signature provided by the user.

19. The system of claim 12, wherein in the unlocked mode, the input provided by the user comprises an interaction between an authenticated device of the user and the locking subsystem.

20. The system of claim 12, wherein the authentication subsystem further comprises a shield coupled to at least one of the EVSE unit and the cable about the authentication subsystem, the shield configured to prevent reading of outside signals unassociated with the identification chip, when the second interface is coupled to the EVSE unit.
